(19) United States
(12) Patent Application Publication
(10) Pub. No.: US 2024/0173983 A1
(43) Pub. Date: May 30, 2024

(54) LIQUID DISCHARGE HEAD AND LIQUID DISCHARGE APPARATUS

(71) Applicant: Hiroki AKIYAMA, IBARAKI (JP)

(72) Inventor: Hiroki AKIYAMA, IBARAKI (JP)

(21) Appl. No.: 18/519,884

(22) Filed: Nov. 27, 2023

(30) Foreign Application Priority Data
Nov. 28, 2022 (JP) 2022-189672

(51) Int. Cl. B41J 2/175

(52) U.S. Cl. CPC B41J 2/175

(57) ABSTRACT

A liquid discharge head includes multiple nozzles, multiple pressure chambers, a common supply channel, and multiple beams. The multiple nozzles discharge liquid. The multiple pressure chambers communicate with the multiple respective nozzles. The common supply channel communicates with the multiple pressure chambers. The common supply channel is shorter in a short-side direction than in a longitudinal direction perpendicular to the short-side direction. The multiple beams are arranged in a truss shape to connect side walls on lateral sides of the common supply channel in the short-side direction of the common supply channel.

### CROSS-REFERENCE TO RELATED APPLICATIONS

This patent application is based on and claims priority pursuant to 35 U.S.C. § 119(a) to Japanese Patent Application No. 2022-189672, filed on Nov. 28, 2022, in the Japan Patent Office, the entire disclosure of which is hereby incorporated by reference herein.

### BACKGROUND

### Technical Field

Embodiments of the present disclosure relate to a liquid discharge head and a liquid discharge apparatus.

### Related Art

A liquid discharge head that discharges liquid includes, for example, a common supply channel as a common liquid chamber shared by multiple pressure chambers. The pressure chambers, which may also be referred to as individual liquid chambers or pressurized liquid chambers, communicate with respective multiple nozzles.

### SUMMARY

In an embodiment of the present disclosure, a liquid discharge head includes multiple nozzles, multiple pressure chambers, a common supply channel, and multiple beams. The multiple nozzles discharge liquid. The multiple pressure chambers communicate with the respective nozzles. The common supply channel communicates with the multiple pressure chambers. The common supply channel is shorter in a short-side direction than in a longitudinal direction perpendicular to the short-side direction. The multiple beams are arranged in a truss shape to connect side walls on lateral sides of the common supply channel in the short-side direction of the common supply channel.

In another embodiment of the present disclosure, a liquid discharge head includes multiple nozzles to discharge liquid, multiple pressure chambers, a common supply channel, a common collection channel, and multiple beams. The multiple pressure chambers communicate with the multiple nozzles. The common supply channel communicate with the multiple pressure chambers. The common supply channel is shorter in a short-side direction than in a longitudinal direction perpendicular to the short-side direction. The common collection channel communicates with the multiple pressure chambers. The multiple beams are arranged in a truss shape to connect side walls on lateral sides of each of the common supply channel and the common collection channel in the short-side direction.

In still another embodiment of the present disclosure, a liquid discharge apparatus includes the liquid discharge head.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an external perspective view of a liquid discharge head according to a first embodiment of the present disclosure;

FIG. 2 is a cross-sectional view of the liquid discharge head of FIG. 1, taken in a direction perpendicular to a direction in which nozzles are arranged;

FIG. 3 is a cross-sectional view of the liquid discharge head of FIG. 1, taken in the direction in which nozzles are arranged;

FIG. 4 is a cross-sectional plan view of a common supply channel and a common collection channel of the liquid discharge head of FIG. 1, taken along a line A-A of FIG. 2;

FIG. 5 is a cross-sectional plan view of a common supply channel and a common collection channel of a liquid discharge head according to a comparative example, taken in the same way as FIG. 4;

FIG. 6 is a cross-sectional view of a liquid discharge head taken in a direction perpendicular to a direction in which nozzles are arranged, according to a second embodiment of the present disclosure;

FIG. 7 is a cross-sectional view of a liquid discharge head taken in a direction perpendicular to a direction in which nozzles of the liquid discharge head are arranged, according to a third embodiment of the present disclosure;

FIG. 8 is a schematic diagram illustrating a printing apparatus as a liquid discharge apparatus, according to an embodiment of the present disclosure; and

FIG. 9 is a plan view of a head unit of the printing apparatus of FIG. 8, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

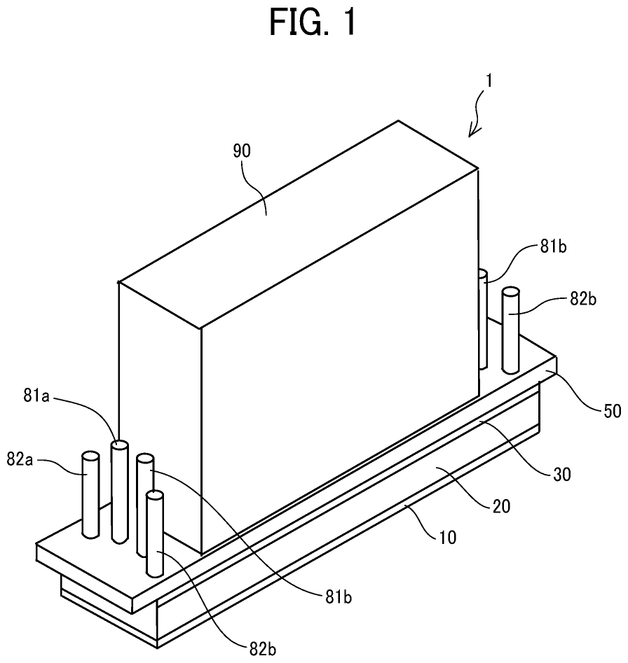

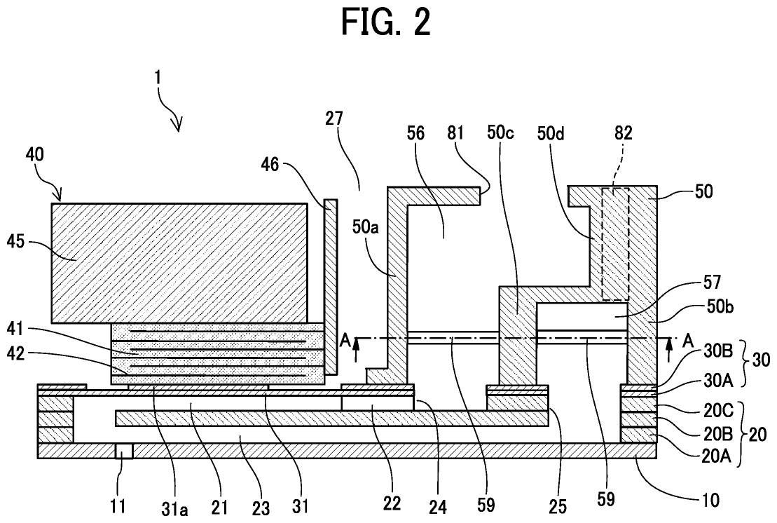

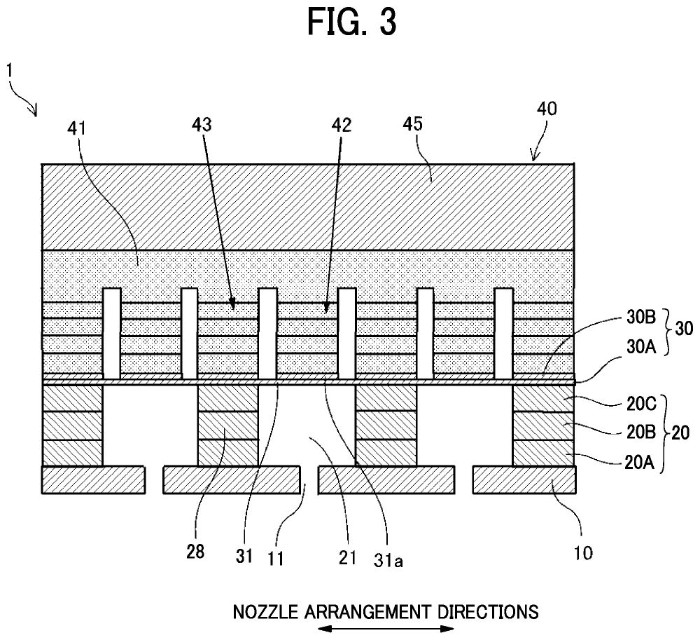

Embodiments of the present disclosure are described below with reference to the attached drawings. A liquid discharge head 1 according to a first embodiment of the present disclosure is described with reference to FIGS. 1, 2, and 3. FIG. 1 is an external perspective view of the liquid discharge head 1, according to the first embodiment of the present disclosure. FIG. 2 is a cross-sectional view of the liquid discharge head 1, taken in a direction perpendicular to a direction in which nozzles are arranged, according to the first embodiment. FIG. 3 is a cross-sectional view of the liquid discharge head 1, taken in the direction in which the nozzles are arranged, according to the first embodiment.

The liquid discharge head 1 is a head having circulation-type pressure chambers, in which a nozzle plate 10, a channel plate 20, and a diaphragm 30 serving as a wall are laminated one on another and bonded to each other. The liquid discharge head 1 further includes a piezoelectric actuator 40, a common channel member 50, and a cover 90. The piezoelectric actuator 40 displaces vibration regions 31 of the diaphragm 30. The common channel member 50 also serves as a frame of the liquid discharge head 1.

The nozzle plate 10 includes a nozzle row in which multiple nozzles 11 are arranged.

The channel plate 20 includes multiple pressure chambers 21, individual supply channels 22, and one or multiple intermediate supply channels 24. The multiple pressure chambers 21 communicates with the respective nozzles 11 via respective nozzle communication channels 27. The individual supply channels 22 serve as fluid restrictors and communicate with the respective pressure chambers 21. The one or multiple intermediate supply channels 24 communicate with one or more of the individual supply channels 22.

The channel plate 20 includes individual collection channels 23 and one or multiple intermediate-collection channels 25. The individual collection channels 23 serve as fluid restrictors and communicate with the respective pressure chambers 21 via the respective nozzle communication channels 27. The one or multiple intermediate-collection channels 25 communicate with one or more of the individual collection channels 23.

In the present embodiment, the channel plate 20 includes three plate members 20A, 20B, and 20C stacked in this order from bottom to top on the nozzle plate 10. The number of plate members in the channel plate 20 is not limited to three.

The diaphragm 30 includes the multiple displaceable vibration regions 31 that form walls of the pressure chambers 21 in the channel plate 20. The diaphragm 30 has a two-layer structure and includes a first layer 30A on the channel plate 20 and a second layer 30B on the first layer 30A. The first layer 30A forms a thin portion of the diaphragm 30 on the channel plate 20 and the second layer 30B forms a thick portion of the diaphragm. The number of layers of the diaphragm is not limited to two.

The displaceable vibration regions 31 are formed in portions of the first layer 30a, which is the thin portion of the diaphragm 30, corresponding to the respective pressure chambers 21. Each of the vibration regions 31 includes an island-shaped convex portion 31a, which is the thick portion of the second layer 30B, bonded to the piezoelectric actuator 40.

The piezoelectric actuator 40 is disposed on a side of the diaphragm 30 opposite another side of the diaphragm 30 facing the pressure chamber 21. The piezoelectric actuator 40 includes electromechanical transducer elements, i.e., piezoelectric elements 42 serving as drivers, i.e., actuators or pressure generators to displace the vibration regions 31 of the diaphragm 30.

The piezoelectric actuator 40 includes a piezoelectric member 41 bonded onto a base 45. The piezoelectric member 41 is grooved by half-cut dicing to form multiple grooves in the piezoelectric member 41. A desired number of columnar piezoelectric elements 42, columns 43, and dummy piezoelectric elements 44 are formed at predetermined intervals in a comb shape in the piezoelectric actuator 40.

The piezoelectric elements 42 are piezoelectric elements to displace the respective vibration regions 31 when a drive voltage is applied to the piezoelectric elements 42.

The columns 43 are piezoelectric elements to support respective partition walls 28 between the pressure chambers 21. The drive voltage is not applied to the columns 43. The dummy piezoelectric elements 44 are piezoelectric elements corresponding to respective dummy pressure chambers 61.

The piezoelectric elements 42 are bonded to the respective convex portions 31a in the vibration regions 31 of the diaphragm 30 with adhesive. The columns 43 are bonded to respective portions of the diaphragm 30 corresponding to the respective partition walls 28 with adhesive.

The piezoelectric member 41 includes piezoelectric layers and internal electrodes alternately laminated one on another. Each of the internal electrodes is led out to an end surface of the piezoelectric member 41 and connected to an external electrode as an end surface electrode. The external electrodes are connected with a flexible wiring member 46 (see FIG. 2).

The common channel member 50 includes a common supply channel 56 and a common collection channel 57. Both of the common supply channel 56 and the common collection channel 57 are collectively referred to as a common channel in the following description. The common supply channel 56 communicates with the intermediate supply channels 24 via a supply opening 32 in the diaphragm 30. The common collection channel 57 communicates with the intermediate-collection channel 25 via a collection opening 33 disposed in the diaphragm 30.

In the present embodiment, the common supply channel 56 and the common collection channel 57 are arranged such that the common collection channel 57 overlaps a part of the common supply channel 56 in a region close to the channel plate 20 in the direction perpendicular to the direction in which the nozzles 11 are arranged, i.e., in a short-side direction of the liquid discharge head 1. The common collection channel 57 overlaps a part of the common supply channel 56 in the plan view.

Accordingly, in the direction perpendicular to the direction in which the nozzles 11 are arranged, i.e., in the short-side direction of the liquid discharge head 1, the common supply channel 56 includes side walls 50a, 50c, and 50d on lateral sides of the common supply channel 56. The common collection channel 57 includes a side wall 50b and the side wall 50c on lateral sides of the common collection channel 57. In other words, the side wall 50c on one lateral side of the common collection channel 57 is common to the side wall 50c that is part of the side walls 50c and 50d on one lateral side of the common supply channel 56.

The common supply channel 56 is connected to a supply port of an external liquid circulation device via supply ports 81a and 81b of a supply inlet 81. The common collection channel 57 is connected to a collection port of the external liquid circulation device via collection ports 82a and 82b of a collection outlet 82.

In the liquid discharge head 1 according to the present embodiment, liquid supplied from the supply port of the external liquid circulation device to the supply inlet 81 is supplied to the pressure chambers 21 through the common supply channel 56, the supply opening 32, the intermediate supply channels 24, and the individual supply channels 22.

The piezoelectric elements 42 are driven such that the liquid that is not discharged from the nozzles 11 is collected from the pressure chambers 21 to the collection port of the external liquid circulation device via the individual collection channels 23, the intermediate-collection channels 25, the collection opening 33, the common collection channel 57, and the collection outlet 82.

When the piezoelectric elements 42 are not driven, the liquid that has been supplied is returned from the pressure chambers 21 to the collection port of the external liquid circulation device via the individual collection channels 23, the intermediate-collection channels 25, the collection opening 33, the common collection channel 57, and the collection outlet 82.

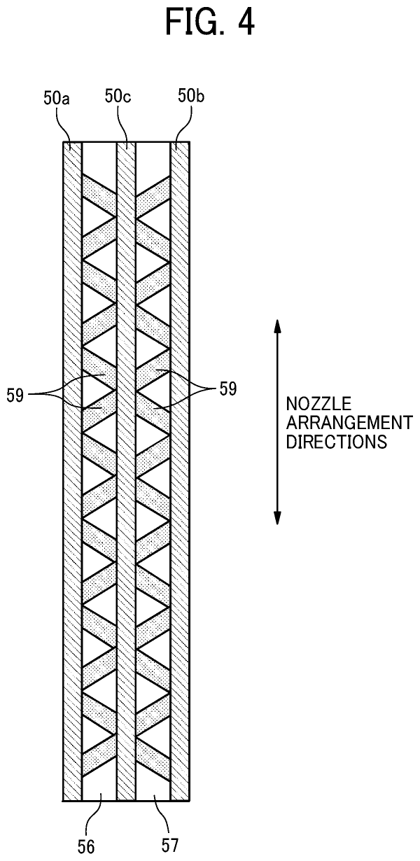

The structure of the common supply channel 56 and the common collection channel 57 as the common channel according to the present embodiment is described below with reference to FIG. 4. FIG. 4 is a cross-sectional plan view of the common supply channel 56 and the common collection channel 57 of the liquid discharge head 1, taken along a line A-A of FIG. 2, according to the present embodiment.

In the common supply channel 56, beams 59 are arranged in a truss shape to connect the side walls 50a and 50c that are disposed on the lateral sides of the common supply channel 56 in the short-side direction, i.e., the direction perpendicular to the direction in which the nozzles 11 are arranged. In the common collection channel 57, beams 59 that are arranged in the truss shape are disposed to connect the side walls 50c and 50b on lateral sides of the common collection channel 57, disposed in the short-side direction.

Accordingly, the rigidity of the side walls 50a and 50c on the lateral sides of the common supply channel 56 and the side walls 50b and 50c on the lateral sides of the common collection channel 57 is enhanced. As a result, the vibration of the liquid discharge head 1 due to deformation of the common channel member 50, which is the frame of the liquid discharge head 1, can be prevented.

Accordingly, the vibration of meniscus of the nozzles 11 can be reduced when the vibration of the common channel member 50, which is the frame of the liquid discharge head 1, is transmitted to the nozzle plate 10. As a result, stable discharge characteristics of the liquid discharge head 1 can be obtained.

In the present embodiment, stress is concentrated on central portions of the side walls 50a and 50c on the lateral sides of the common supply channel 56 and central portions of the side walls 50b and 50c on the lateral sides of the common collection channel 57 in the height direction. For this reason, the beams 59 are arranged in the central portions of the side walls 50a, 50b, 50c, and 50d in the height direction. By so doing, the vibration of the liquid discharge head 1 due to deformation of the common channel member 50, which is the frame of the liquid discharge head 1, can be more effectively prevented. As in the present embodiment, when the beams 59 are disposed in the common supply channel 56 and the common collection channel 57, the beams 59 are arranged in the central portion of the side wall 50c in the height direction, which is shared by both the common supply channel 56 and the common collection channel 57.

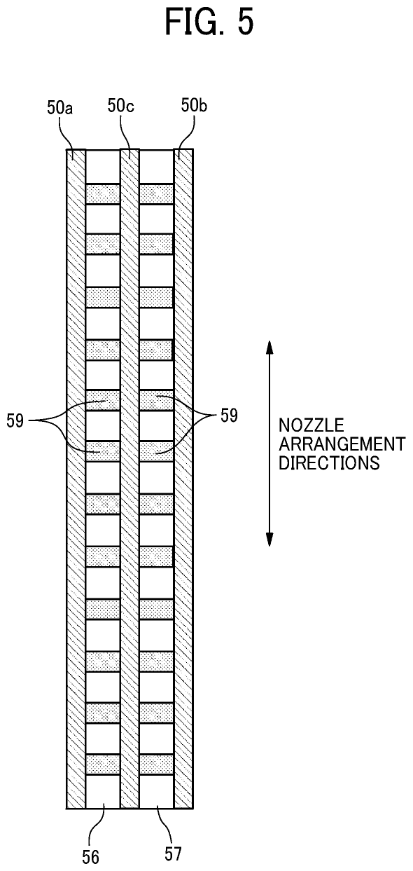

The arrangement of beams 59 according to a comparative example of the present disclosure is described with reference to FIG. 5. FIG. 5 is a cross-sectional plan view of a common supply channel 56 and a common collection channel 57 according to the comparative example of the present disclosure, taken in the same way as FIG. 4.

In the comparative example, the beams 59 are arranged to connect side walls 50a and 50c on the lateral sides of the common supply channel 56 and side walls 50b and 50c on the lateral sides of the common collection channel 57. The beams 59 are arranged at predetermined intervals in the longitudinal direction of the common supply channel 56 and the common collection channel 57, i.e., the direction in which nozzles 11 are arranged. Each of the beams 59 extends in the direction perpendicular to the direction in which the nozzles 11 are arranged.

In the arrangement of the beams 59 according to the comparative example, each of the common supply channel 56 and the common collection channel 57 includes portions in which the beams 59 are present and portions in which the beams 59 are absent in the longitudinal direction. Accordingly, the discharge characteristics of the liquid discharge head 1 may vary depending on the positions of the nozzles 11.

By contrast, arranging the beams 59 in the truss shape as in the above-described embodiments can reduce the variation of the discharge characteristics of the liquid discharge head 1, which may occur depending on the positions of the nozzles 11.

In the liquid discharge head 1 as the head having the circulation-type pressure chambers including the common supply channel 56 and the common collection channel 57, the beams 59 are disposed between the side walls 50a and 50c of the common supply channel 56 and between both side walls 50c and 50b of the common collection channel 57. However, embodiments of the present disclosure are not limited to such a configuration. In other words, even if the beams are arranged in the truss shape either between the side walls 50a and 50c of the common supply channel 56 or between the side walls 50c and 50b of the common collection channel 57, the above-described functional effect can be obtained within a limit of such a configuration.

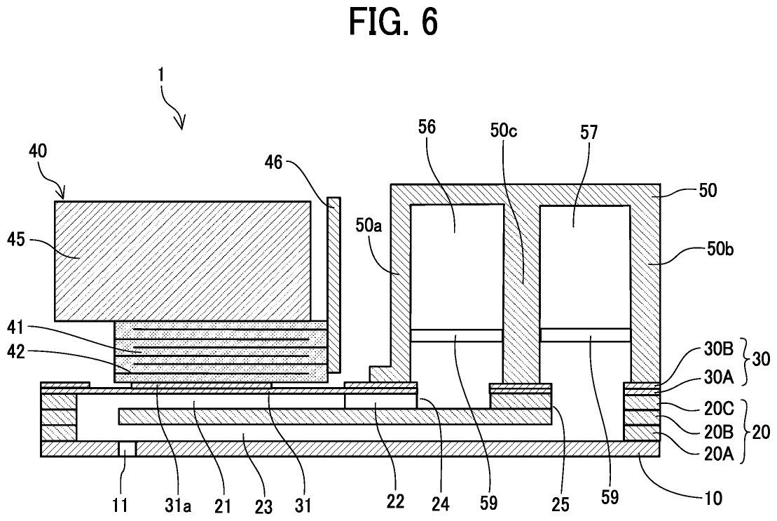

A liquid discharge head 1 according to a second embodiment of the present disclosure is described with reference to FIG. 6.

FIG. 6 is a cross-sectional view of the liquid discharge head 1 taken in the direction perpendicular to the direction in which nozzles 11 are arranged, according to the second embodiment of the present disclosure.

The liquid discharge head 1 of the present embodiment is a head having circulation-type pressure chambers and includes a common supply channel 56 and a common collection channel 57. In the present embodiment, the common supply channel 56 and the common collection channel 57 are arranged side by side in the direction perpendicular to the direction in which the nozzles 11 are arranged. However, unlike the first embodiment, the common supply channel 56 and the common collection channel 57 are arranged such that the common supply channel 56 and the common collection channel 57 do not partially overlap each other in the plan view.

In the common supply channel 56, beams 59, which are arranged in a truss shape connecting side walls 50a and 50c on the lateral sides of the common supply channel 56, are disposed at a position closer to the nozzle plate 10 in the height direction than a center portion of the side walls 50a and 50c on the lateral sides of the common supply channel 56 in the height direction is disposed. In the common collection channel 57, beams 59, which are arranged in a truss shape connecting side walls 50b and 50c on the lateral sides of the common collection channel 57, are disposed at a position closer to the nozzle plate 10 than a center portion of the side walls 50b and 50c on the lateral sides of the common collection channel 57 in the height direction is disposed. However, similar to the above-described first embodiment, the beams 59 may be disposed at the center portions of the side walls 50a and 50c of the common supply channel 56 and the side walls 50c and 50b of the common collection channel 57 in the height direction. The beams 59 may be disposed in only one of the common supply channel 56 and the common collection channel 57.

Also in the present embodiment, the discharge characteristics of the liquid discharge head 1 can be stabilized as compared with a case in which the beams 59 are not disposed in the common supply channel 56 and the common collection channel 57.

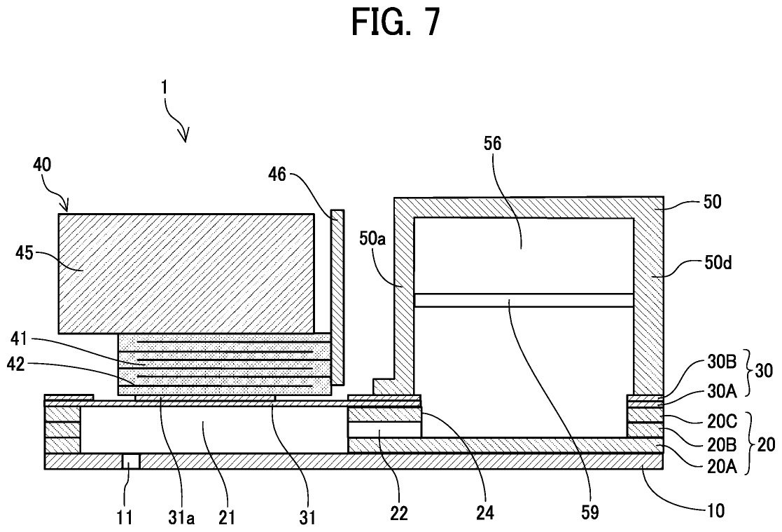

FIG. 7 is a cross-sectional view of a liquid discharge head 1 taken in the direction perpendicular to the direction in which nozzles 11 are arranged, according to an embodiment of the present disclosure.

The liquid discharge head 1 of the present embodiment is not a circulation-type head. The liquid discharge head 1 of the present embodiment includes only a common supply channel 56 and does not include a channel including a common collection channel 57 to collect liquid.

The beams 59 that are arranged in the truss shape connecting side walls 50a and 50c are disposed at central portions of side walls 50a and 50c on the lateral sides of the common supply channel 56 in the height direction. However, similar to the first embodiment, the beams 59 may be disposed at a position away from the central portions of the side walls 50a and 50c in the height direction.

Also in the present embodiment, the discharge characteristics of the liquid discharge head 1 can be stabilized as compared with a case in which the beams 59 are not disposed in the common supply channel 56 and the common collection channel 57.

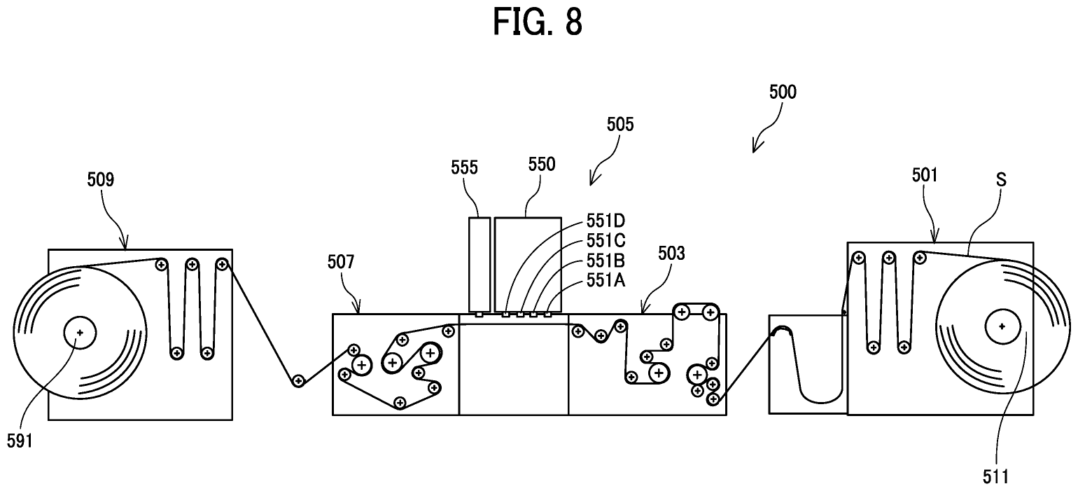

FIG. 8 is a schematic diagram illustrating a printing apparatus 500 as a liquid discharge apparatus, according to an embodiment of the present disclosure.

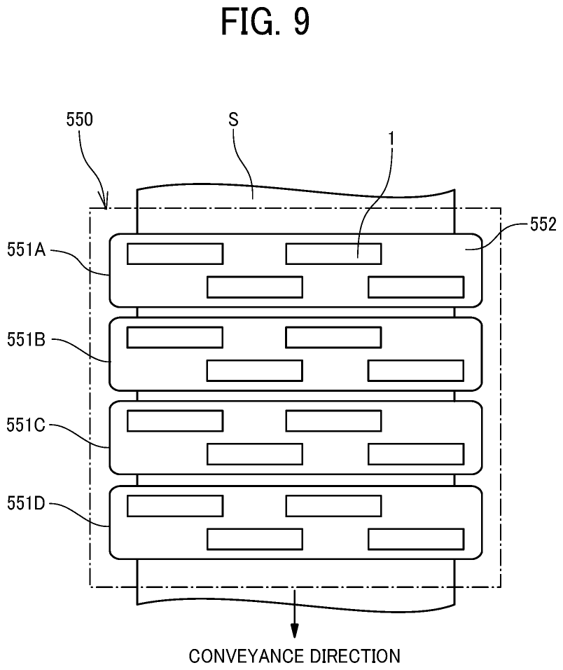

FIG. 9 is a plan view of a head unit 550 of the printing apparatus 500 as the liquid discharge apparatus, according to an embodiment of the present disclosure.

The printing apparatus 500 is an apparatus that discharges liquid. The printing apparatus 500 includes, for example, a feeder 501, a guide conveyor 503, a printer 505, a drier 507, and an ejector 509.

The feeder 501 feeds a web-shaped sheet S as a medium. The guide conveyor 503 guides and conveys the sheet S conveyed by the feeder 501 to the printer 505. The printer 505 discharges liquid onto the sheet S to form an image on the sheet S to perform printing. The drier 507 dries the sheet S. The ejector 509 ejects the sheet S.

The sheet S is fed from a feed roller 511 of the feeder 501, guided and conveyed by rollers of the feeder 501, the guide conveyor 503, the drier 507, and the ejector 509, to be wound around a winding roller 591 of the ejector 509.

In the printer 505, the sheet S is conveyed facing the head unit 550 and the head device 555. The head unit 550 discharges liquid onto a sheet S to form an image on the sheet S. The head device 555 discharges a treatment liquid onto the sheet S to perform a post-treatment processing.

In the present embodiment, the head unit 550 includes, for example, four color full-line head arrays 551A, 551B, 551C, and 551D arranged from upstream in a conveyance direction of the sheet S, i.e., a direction from right to left in FIG. 11. The full-line head arrays 551A, 551B, 551C, and 551D may be referred simply to as a head array 551 when colors of liquid discharged from the full-line head arrays 551A, 551B, 551C, and 551D are not distinguished.

The head arrays 551A, 551B, 551C, and 551D are liquid dischargers to discharge liquid of, for example, black (K), cyan (C), magenta (M), and yellow (Y), respectively, onto a conveyed sheet S. The type and number of the colors discharged from the head array 551 are not limited to the above-described example.

In the head array 551, for example, the liquid discharge heads 1 according to the above-described embodiments of the present disclosure are arranged in a staggered manner on a base 552. However, embodiments of the present disclosure are not limited to such an arrangement of the liquid discharge heads 1.

In embodiments of the present disclosure, the liquid to be discharged is not limited to a particular liquid as long as the liquid has a viscosity or surface tension to be discharged from liquid discharge head 1. However, preferably, the viscosity of the liquid is not greater than 30 mPa's under ordinary temperature and ordinary pressure or by heating or cooling. Specific examples of such liquids include, but are not limited to, solutions, suspensions, and emulsions containing solvents such as water, organic solvents, colorants such as dyes, pigments, functionality imparting materials such as polymerizable compounds, resins, surfactants, biocompatible materials such as deoxyribonucleic acid (DNA), amino acid, protein, calcium, and/or edible materials such as natural colorants. Such liquids can be used as, for example, inkjet inks, surface treatment liquids, liquids for forming compositional elements of electric or luminous elements or electronic circuit resist patterns, and three-dimensional object forming material liquids.

Examples of an energy source for generating energy to discharge liquid include a piezoelectric actuator, i.e., a laminated piezoelectric element or a thin-film piezoelectric element, a thermal actuator that employs a thermoelectric conversion element, such as a thermal resistor, and an electrostatic actuator including a diaphragm and opposed electrodes.

Examples of the liquid discharge apparatus includes an apparatus which includes liquid discharge heads and drives the liquid discharge heads to discharge liquid. Examples of the liquid discharge apparatus include an apparatus discharging liquid to a material onto which the liquid can adhere and an apparatus to discharge liquid toward gas or into liquid.

The liquid discharge apparatus described in the above-described embodiments may include, for example, devices to feed, convey, and eject materials onto which liquid can adhere and may further include, for example, a pretreatment apparatus to apply a pretreatment liquid onto the material, and a post-treatment apparatus to apply a post-treatment liquid onto the material.

Examples of the liquid discharge apparatus may include, for example, an image forming apparatus that discharges ink to form an image on a sheet, or a stereoscopic fabrication apparatus, i.e., a three-dimensional fabrication apparatus to discharge a molding liquid to a powder layer in which powder material is formed in layers to form a three-dimensional object.

The liquid discharge apparatus is not limited to an apparatus to discharge liquid to visualize meaningful images, such as letters or figures. For example, the liquid discharge apparatus may be an apparatus that forms meaningless images such as meaningless patterns or an apparatus that fabricates three-dimensional images.

The above-described term “material onto which liquid can adhere” denotes, for example, a material or a medium onto which liquid is adhered at least temporarily, a material or a medium onto which liquid is adhered and fixed, or a material or a medium onto which liquid is adhered and into which the liquid permeates. Examples of the “material onto which liquid can adhere” include recording media or medium such as a sheet of paper, a recording paper, and a recording sheet of paper, film, and cloth, electronic components such as an electronic substrate and a piezoelectric element, and media or medium such as a powder layer, an organ model, and a testing cell. The “material onto which liquid can adhere” includes any material on which liquid adheres unless particularly limited.

The above-mentioned “material onto which liquid can adhere” may be any material as long as liquid can temporarily adhere such as paper, thread, fiber, cloth, leather, metal, plastic, glass, wood, or ceramics.

The liquid discharge apparatus may be an apparatus to relatively move a liquid discharge head and a material on which liquid can be adhered. However, the liquid discharge apparatus is not limited to such an apparatus. For example, the liquid discharge apparatus may be a serial head apparatus that moves a liquid discharge head or a line head apparatus that does not move a liquid discharge head.

Examples of the liquid discharge apparatus further include a treatment-liquid coating apparatus to discharge a treatment liquid to a sheet to coat the treatment liquid on a sheet surface of the sheet to modify the sheet surface and an injection granulation apparatus in which a composition liquid including raw materials dispersed in a solution is discharged through nozzles to granulate fine particles of the raw materials.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A liquid discharge head comprising:
a plurality of nozzles to discharge liquid;
a plurality of pressure chambers communicating with the plurality of respective nozzles;
a common supply channel communicating with the plurality of pressure chambers, the common supply channel being shorter in a short-side direction than in a longitudinal direction perpendicular to the short-side direction; and
a plurality of beams arranged in a truss shape to connect side walls on lateral sides of the common supply channel in the short-side direction of the common supply channel.

2. A liquid discharge head comprising:
a plurality of nozzles to discharge liquid;
a plurality of pressure chambers communicating with the plurality of nozzles;
a common supply channel communicating with the plurality of pressure chambers, the common supply channel being shorter in a short-side direction than in a longitudinal direction perpendicular to the short-side direction;
a common collection channel communicating with the plurality of pressure chambers; and
a plurality of beams arranged in a truss shape to connect side walls on lateral sides of each of the common supply channel and the common collection channel in the short-side direction.

3. The liquid discharge head according to claim 2,
wherein one of the side walls on the lateral sides of the common collection channel is common to a portion of one of the side walls on the lateral sides of the common supply channel.

4. The liquid discharge head according to claim 2,
wherein the plurality of beams of the common collection channel are disposed at a central portion of the side walls in a height direction of the common collection channel.

5. A liquid discharge apparatus comprising the liquid discharge head according to claim 1.
